(19) United States
(12) Patent Application Publication
(10) Pub. No.: US 2020/0156646 A1
(43) Pub. Date: May 21, 2020

(54) ROAD DEGRADATION INFORMATION COLLECTING DEVICE

(71) Applicant: AISIN SEIKI KABUSHIKI KAISHA, Kariya-shi (JP)

(72) Inventors: Toshiro Umemura, Kariya-shi (JP); Toshiaki Hamada, Kariya-shi (JP); Shuji Yamamoto, Kariya-shi (JP)

(73) Assignee: AISIN SEIKI KABUSHIKI KAISHA, Kariya-shi (JP)

(21) Appl. No.: 16/684,667

(22) Filed: Nov. 15, 2019

(30) Foreign Application Priority Data
Nov. 19, 2018 (JP) 2018-216793

(51) Int. Cl. B60W 40/06; B60W 40/105; G06K 9/00

(52) U.S. Cl. CPC B60W 40/06; B60W 40/105; B60W 2420/42; B60W 2520/105; G06K 9/00791

(57) ABSTRACT

A road degradation information collecting device includes: a position detection unit that detects a traveling position of a vehicle; a speed detection unit that detects a speed of the vehicle; a degradation detection unit that detects degradation in a road surface of a road where the vehicle is traveling; a timing calculation unit that calculates a timing at which the vehicle passes through a position separated by a predetermined distance from a degradation position that is the traveling position at which the degradation is detected among traveling positions detected by the position detection unit on the basis of the speed detected by the speed detection unit; and a recording control unit that records a captured image obtained by imaging the road surface with an imaging unit the vehicle at the timing calculated by the timing calculation unit, on a storage unit in correlation with the degradation position.

### CROSS REFERENCE TO RELATED APPLICATIONS

This application is based on and claims priority under 35 U.S.C. § 119 to Japanese Patent Application 2018-216793, filed on Nov. 19, 2018, the entire contents of which are incorporated herein by reference.

### TECHNICAL FIELD

An embodiment of this disclosure relates to a road degradation information collecting device.

### BACKGROUND DISCUSSION

A technique has been developed in which an acceleration applied to a vehicle is detected by an acceleration sensor, degradation in a road on which the vehicle is traveling is detected on the basis of a detection result of the acceleration, a road surface of the road on which the vehicle has passed is imaged by an imaging unit mounted on the vehicle when the degradation in the road surface is detected, and image data obtained through the imaging is transmitted to an external apparatus.

Japanese Patent No. 6369654 and JP 2015-176540A are examples of the related art.

Meanwhile, a speed at which the vehicle is traveling on the road changes depending on situations or the like of the road. Thus, even though the imaging unit images the road surface on which the vehicle has passed when the degradation in the road is detected, in a case where speeds of the vehicle are different from each other, reflection of the degradation in the road into the image data differs for each piece of image data, and thus analysis of the degradation in the road using the image data may be complex.

Thus, a need exists for a road degradation information collecting device which is not susceptible to the drawback mentioned above.

### SUMMARY

As an example, a road degradation information collecting device according to an aspect of this disclosure includes a position detection unit that detects a traveling position of a vehicle; a speed detection unit that detects a speed of the vehicle; a degradation detection unit that detects degradation in a road surface of a road on which the vehicle is traveling; a timing calculation unit that calculates a timing at which the vehicle passes through a position separated by a predetermined distance from a degradation position that is the traveling position at which the degradation in the road surface is detected among traveling positions detected by the position detection unit on the basis of the speed detected by the speed detection unit; and a recording control unit that records a captured image obtained by imaging the road surface with an imaging unit mounted on the vehicle at the timing calculated by the timing calculation unit, on a storage unit in correlation with the degradation position.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating an example of a state in which a part of a vehicle cabin of a vehicle mounted with a road degradation information collecting device according to the present embodiment is viewed;

FIG. 2 is a plan view illustrating an example of a vehicle according to the present embodiment;

FIG. 3 is a block diagram illustrating an example of a functional configuration of the vehicle according to the present embodiment;

FIG. 4 is a block diagram illustrating an example of a functional configuration of an ECU of the vehicle according to the present embodiment; and

FIG. 5 is a flowchart illustrating an example of a captured image recording process performed by the ECU of the vehicle according to the present embodiment.

### DETAILED DESCRIPTION

Hereinafter, an exemplary embodiment disclosed here will be described. Configurations of the embodiment described below, and operations, results, and effects resulting from the configurations are only examples. The present embodiment described here can be realized according to configurations other than configurations disclosed in the following embodiment, and can achieve at least one of various effects based on the fundamental configuration or derivative effects.

A vehicle mounted with a road degradation information collecting device according to the present embodiment may be an automobile (internal combustion engine automobile) having an internal combustion engine (engine) as a drive source, may be an automobile (an electric car, a fuel cell automobile, or the like) having an electric motor (motor), and may be an automobile (hybrid car) having both of the two as drive sources. The vehicle is mountable with various transmission devices and various devices (systems, components, or the like) required to drive an internal combustion engine or an electric motor. Methods, the number, layouts, and the like of devices related to driving of wheels of the vehicle may be variously set.

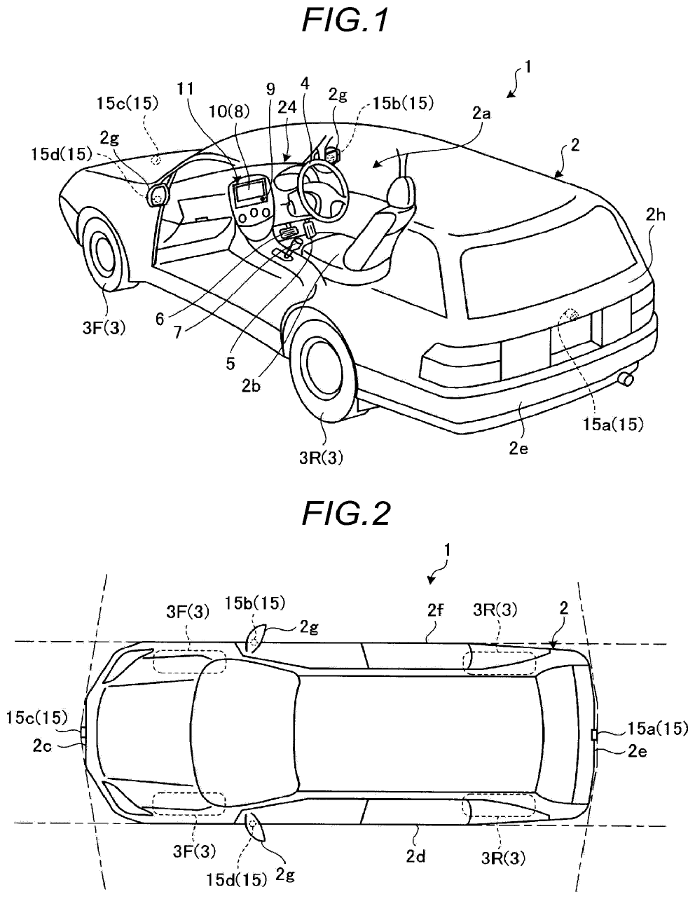

FIG. 1 is a perspective view illustrating an example of a state in which a part of a vehicle cabin of a vehicle mounted with a road degradation information collecting device according to the present embodiment is viewed. As illustrated in FIG. 1, a vehicle 1 includes a vehicle body 2, a steering unit 4, an acceleration operation unit 5, a braking operation unit 6, a transmission operation unit 7, and a monitor apparatus 11. The vehicle body 2 has a vehicle cabin 2a on which an occupant rides. The steering unit 4, the acceleration operation unit 5, the braking operation unit 6, the transmission operation unit 7, and the like are provided in the vehicle cabin 2a in a state of facing a seat 2b on which a driver as an occupant sits. The steering unit 4 is, for example, a steering wheel protruding from a dashboard 24. The acceleration operation unit 5 is, for example, an accelerator pedal located under the driver's foot. The braking operation unit 6 is, for example, a brake pedal located under the driver's foot. The transmission operation unit 7 is, for example, a shift lever protruding from a center console.

The monitor apparatus 11 is provided, for example, at the center of the dashboard 24 in a vehicle width direction (that is, a leftward-rightward direction). The monitor apparatus 11 may have a function such as a navigation system or an audio system. The monitor apparatus 11 has a display device 8, a sound output device 9, and an operation input unit 10. The monitor apparatus 11 may have various operation input units such as a switch, a dial, a joystick, and a push button.

The display device 8 is configured with a liquid crystal display (LCD) or an organic electroluminescent display (OELD), and displays various images on the basis of image data. The sound output device 9 is configured with a speaker or the like, and outputs various sounds on the basis of sound data. The sound output device 9 may be provided at positions other than the monitor apparatus 11 in the vehicle cabin 2a.

The operation input unit 10 is configured with a touch panel or the like, and allows an occupant to input various pieces of information. The operation input unit 10 is provided on a display screen of the display device 8, and transmits an image displayed on the display device 8 therethrough. Consequently, the operation input unit 10 enables an image displayed on the display screen of the display device 8 to be visually recognized by an occupant. The operation input unit 10 detects a touch operation of the occupant on the display screen of the display device 8, and thus receives input of various pieces of information from the occupant.

FIG. 2 is a plan view illustrating an example of the vehicle according to the present embodiment. As illustrated in FIGS. 1 and 2, the vehicle 1 is a four-wheeled automobile having two left and right front wheels 3F and two left and right rear wheels 3R. Some or all of the four vehicle wheels 3 are turnable.

The vehicle 1 is mounted with imaging units 15 (on-vehicle camera) that images a road surface of a road on which the vehicle 1 is traveling. In the present embodiment, the vehicle 1 is mounted with, for example, four imaging units 15a to 15d. The imaging unit 15 is a digital camera having an imaging element such as a charge coupled device (CCD) or a CMOS image sensor (CIS). The imaging unit 15 images the periphery of the vehicle 1 at a predetermined frame rate. The imaging unit 15 outputs a captured image obtained by imaging the periphery of the vehicle 1. Each imaging unit 15 has a wide-angle lens or a fisheye lens, and images a range of, for example, 140° to 220° in the horizontal direction. An optical axis of the imaging unit 15 may be set to be directed obliquely downward.

Specifically, the imaging unit 15a is located, for example, at an end 2e of a rear side of the vehicle body 2, and is provided on a wall part under a rear window of a door 2h of a rear hatch. The imaging unit 15a is a rear camera provided to image the rear of the vehicle 1 on the periphery of the vehicle 1. The imaging unit 15b is located, for example, at an end 2f of a right side of the vehicle body 2, and is provided in a right door mirror 2g. The imaging unit 15b images the lateral side of the vehicle on the periphery of the vehicle 1. The imaging unit 15c is located, for example, at an end 2c of a front side of the vehicle body 2, that is, the front side of the vehicle 1 in a front-rear direction, and is provided on a front bumper or a front grill. The imaging unit 15c is a front camera provided to image the front of the vehicle 1 on the periphery of the vehicle 1. The imaging unit 15d is located, for example, at an end 2d of a left side of the vehicle body 2, that is, the left side in a vehicle width direction, and is provided in a left door mirror 2g. The imaging unit 15d images the lateral side of the vehicle 1 on the periphery of the vehicle 1.

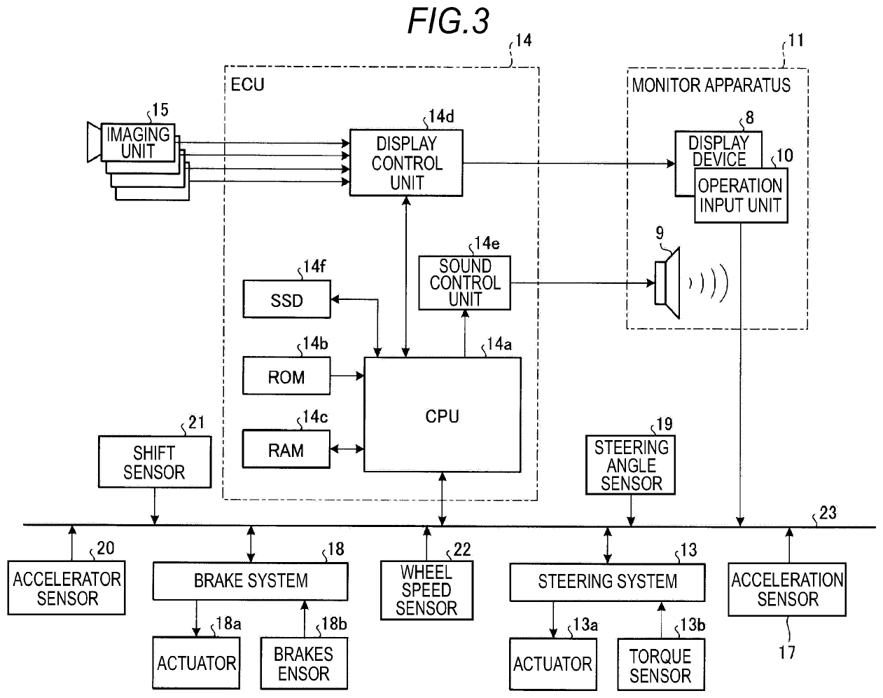

FIG. 3 is a block diagram illustrating an example of a functional configuration of the vehicle according to the present embodiment. As illustrated in FIG. 3, the vehicle 1 includes a steering system 13, an acceleration sensor 17, a brake system 18, a steering angle sensor 19, an accelerator sensor 20, a shift sensor 21, a wheel speed sensor 22, an on-vehicle network 23, and an electronic control unit (ECU) 14. The monitor apparatus 11, the steering system 13, the acceleration sensor 17, the brake system 18, the steering angle sensor 19, the accelerator sensor 20, the shift sensor 21, the wheel speed sensor 22, and the ECU 14 are electrically coupled to each other via the on-vehicle network 23 as an electric communication channel. The on-vehicle network 23 is configured with, for example, a controller area network (CAN).

The steering system 13 is, for example, an electric power steering system or a steer by wire (SBW) system. The steering system 13 has an actuator 13a and a torque sensor 13b. The steering system 13 is electrically controlled by the ECU 14 or the like to operate the actuator 13a, and thus applies torque to the steering unit 4 to be supplemented with steering force such that the vehicle wheels 3 are turned. The torque sensor 13b detects torque applied to the steering unit 4 by a driver, and transmits a detection result thereof to the ECU 14.

The acceleration sensor 17 detects an acceleration applied to the vehicle 1, and outputs the detected acceleration to the ECU 14 via the on-vehicle network 23. In the present embodiment, the acceleration sensor 17 detects an acceleration in at least one direction among the front-rear direction, the leftward-rightward direction, and the upward-downward direction of the vehicle 1.

The brake system 18 includes an anti-lock brake system (ABS) controlling locking of a brake of the vehicle 1, a sideslip prevention device (electronic stability control: ESC) restricting sideslip of the vehicle 1 during cornering, an electric brake system assisting the brake by enhancing braking force, and a brake by wire (BBW). The brake system 18 has an actuator 18a and a brake sensor 18b. The brake system 18 is electrically controlled by the ECU 14 or the like to apply braking force to the vehicle wheels 3 via the actuator 18a. The brake system 18 executes control of detecting locking of the brake, idle rotation of the vehicle wheels 3, and a sign of sideslip on the basis of a rotation difference between the left and right vehicle wheels 3, and suppressing the locking of the brake, the idle rotation of the vehicle wheels 3, and the sideslip.

The brake sensor 18b is a displacement sensor detecting a position of the brake pedal as a movable portion of the braking operation unit 6, and transmits a detection result of the position of the brake pedal to the ECU 14. In the present embodiment, the brake sensor 18b functions as an example of an operation detection unit detecting an operation on the braking operation unit 6.

The steering angle sensor 19 is a sensor detecting a steering amount of the steering unit 4 such as a steering wheel. In the present embodiment, the steering angle sensor 19 is configured with a hole element or the like, detects a rotation angle of a rotation portion of the steering unit 4 as a steering amount, and transmits a detection result thereof to the ECU 14. In the present embodiment, the steering angle sensor 19 functions as an example of an operation detection unit detecting an operation (steering) on the steering unit 4.

The accelerator sensor 20 is a displacement sensor detecting a position of the accelerator pedal as a movable portion of the acceleration operation unit 5, and transmits a detection result thereof to the ECU 14.

The shift sensor 21 is a sensor detecting a position of a movable portion (a bar, an arm, a button, or the like) of the transmission operation unit 7, and transmits a detection result thereof to the ECU 14. The wheel speed sensor 22 is a sensor having a hole element or the like and detecting a rotation angle of the vehicle wheels 3 or a rotation speed of the vehicle wheels 3 per unit time, and transmits a detection result thereof to the ECU 14.

The ECU 14 is configured with a computer or the like, and controls the whole of the vehicle 1 in cooperation between hardware and software. Specifically, the ECU 14 includes a central processing unit (CPU) 14a, a read only memory (ROM) 14b, a random access memory (RAM) 14c, a display control unit 14d, a sound control unit 14e, and a solid state drive (SSD) 14f. The CPU 14a, the ROM 14b, and the RAM 14c may be provided on an identical circuit board.

The CPU 14a reads a program stored in a nonvolatile storage device such as the ROM 14b, and executes various calculation processes according to the program. For example, the CPU 14a executes image processing or the like on image data to be displayed on the display device 8.

The ROM 14b stores various programs and parameters required to execute the programs. The RAM 14c temporarily stores various pieces of data used for calculation in the CPU 14a. Among calculation processes in the ECU 14, generally, the display control unit 14d executes image processing on image data that is acquired from the imaging unit 15 and is output to the CPU 14a, conversion from image data acquired from the CPU 14a into image data to be displayed on the display device 8, recording of a captured image obtained by imaging a position where a road degrades with the imaging unit 15, and the like. Among the calculation processes in the ECU 14, the sound control unit 14e generally executes a process on sounds that are acquired from the CPU 14a and are output from the sound output device 9. The SSD 14f is a rewritable nonvolatile storage unit, and still stores data acquired from the CPU 14a even in a case where the ECU 14 is powered off.

Meanwhile, cost required for road surface repair work or the like for a road may be covered by subsidies paid by the Ministry of Land, Infrastructure, Transport and Tourism. The subsidies are paid according to an evaluation result of a road surface state on the basis of a maintenance control index (MCI) that is derived through road surface property examination. Thus, when a road surface is checked, a road surface property in a section of a checking target road is performed by a road surface property measurement vehicle, and thus an MCI is calculated. However, it requires time and cost for the road surface property measurement vehicle to examine road surface properties of all roads on which vehicles travel.

Thus, as a technique enabling degradation in a road surface to be detected at low cost, there is the need for development of a technique in which a vehicle mounted with an acceleration sensor is caused to travel, a detection result of the acceleration in the acceleration sensor is compared with a predetermined degradation reference such that degradation in the road surface is detected, and a road surface property measurement vehicle is operated focusing on a position of the detected degradation. According to the technique, the road surface property measurement vehicle can be efficiently operated, and thus it is possible to reduce cost required to examine a road surface property.

Therefore, in the present embodiment, the vehicle has a function of detecting the acceleration applied to the vehicle 1 in the acceleration sensor 17, detecting degradation in a road surface on the basis of a detection result of the acceleration, imaging the road surface in the imaging unit 15 when the degradation is detected, and recording a captured image obtained through the imaging into a storage unit such as the SSD 14f. Thus, a road surface property measurement vehicle can be efficiently operated, for example, by the present device narrowing an operation location of the road surface property measurement vehicle, and it is also possible to reduce cost required to examine a road surface property.

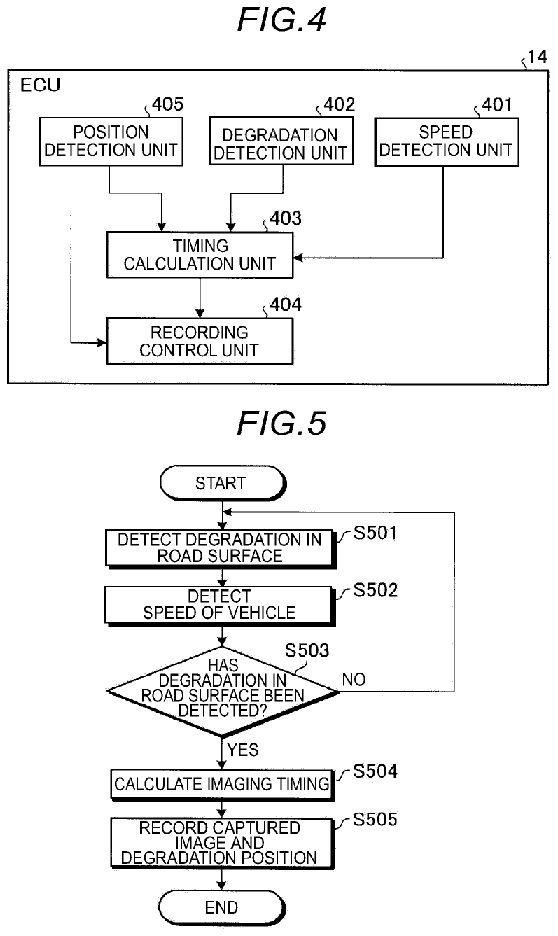

FIG. 4 is a block diagram illustrating an example of a functional configuration of the ECU of the vehicle according to the present embodiment. As illustrated in FIG. 4, the ECU 14 includes a speed detection unit 401, a degradation detection unit 402, a timing calculation unit 403, a recording control unit 404, and a position detection unit 405. For example, a processor such as the CPU 14a mounted on a circuit board executes a camera calibration program stored in a storage medium such as the ROM 14b or the SSD 14f, and thus the ECU 14 realizes functions of the speed detection unit 401, the degradation detection unit 402, the timing calculation unit 403, the recording control unit 404, and the position detection unit 405. Some or all of the speed detection unit 401, the degradation detection unit 402, the timing calculation unit 403, the recording control unit 404, and the position detection unit 405 may be configured by hardware such as circuits. In the present embodiment, the ECU 14 functions as an example of a road degradation information collecting device.

The position detection unit 405 detects a traveling position (current position) of the vehicle 1 on the basis of radio waves received by a global positioning system (GPS) receiver (not illustrated).

In the present embodiment, the position detection unit 405 detects a traveling position of the vehicle 1 on the basis of radio waves or the like received by the GPS receiver (not illustrated), but is not limited thereto, and may detect the current position of the vehicle 1 estimated according to a position estimation method such as odometry or dead reckoning, as a traveling position of the vehicle 1.

The speed detection unit 401 detects a speed of the vehicle 1. In the present embodiment, the speed detection unit 401 detects a speed of the vehicle 1 on the basis of a detection result of a rotation speed of the vehicle wheels 3 in the wheel speed sensor 22.

In the present embodiment, the speed detection unit 401 detects a speed of the vehicle 1 on the basis of a detection result of a rotation speed of the vehicle wheels 3 in the wheel speed sensor 22, but is not limited thereto, and may detect a speed of the vehicle 1 by using map information indicating a position of the vehicle 1, the current position of the vehicle 1 acquired on the basis of radio waves received by the GPS receiver (not illustrated), and a detection result of acceleration in the acceleration sensor 17.

The degradation detection unit 402 detects degradation in a road surface of a road on which the vehicle 1 is traveling. In the present embodiment, the degradation detection unit 402 detects degradation in a road surface on the basis of a detection result of acceleration in the acceleration sensor 17. Consequently, degradation in a road surface can be detected on the basis of actual impact applied to the vehicle 1, and thus it is possible to improve the accuracy of detecting the degradation in the road surface required to be repaired.

Specifically, in a case where a pattern (waveform) of a change in a direction in which the acceleration detected by the acceleration sensor 17 is applied is different from a preset pattern (waveform), the degradation detection unit 402 detects degradation in a road surface. Consequently, degradation in a road surface can be detected on the basis of actual impact applied to the vehicle 1, and thus it is possible to improve the accuracy of detecting the degradation in the road surface required to be repaired. Here, the preset pattern is a waveform of a change in which the acceleration detected by the acceleration sensor 17 is applied in a case where the vehicle 1 is traveling on a road of which a road surface does not degrade.

For example, in a case where a pattern of a change in a direction in which the acceleration detected by the acceleration sensor 17 is applied is a pattern in which the vehicle 1 vibrates in the upward-downward direction, the degradation detection unit 402 determines that a vehicle 1 has passed on an unevenness generated due to degradation in a road surface, and thus detects the degradation in the road surface.

For example, in a case where a pattern of a change in a direction in which the acceleration detected by the acceleration sensor 17 is applied is a pattern in which the vehicle 1 vibrates in the leftward-rightward direction, the degradation detection unit 402 determines that a vehicle 1 has avoided an unevenness generated due to degradation in a road surface, and thus detects the degradation in the road surface.

The degradation detection unit 402 detects degradation in a road surface in a case where a change amount (difference) of the acceleration detected by the acceleration sensor 17 based on, as a reference, the acceleration applied to the vehicle 1 traveling on a road of which a road surface does not degrade is equal to or more than a preset threshold value. Consequently, degradation in a road surface can be detected on the basis of actual impact applied to the vehicle 1, and thus it is possible to improve the accuracy of detecting the degradation in the road surface required to be repaired.

For example, in a case where a change amount of the acceleration applied upward, detected by the acceleration sensor 17, is equal to or more than the preset threshold value, the degradation detection unit 402 determines that the vehicle 1 has passed on a protrusion generated due to degradation in a road surface, and thus detects the degradation in the road surface. For example, in a case where a change amount of the acceleration applied downward, detected by the acceleration sensor 17, is equal to or more than the preset threshold value, the degradation detection unit 402 determines that the vehicle 1 has passed on a depression generated due to degradation in a road surface, and thus detects the degradation in the road surface.

The degradation detection unit 402 detects rolling of the vehicle 1 due to one vehicle wheel 3 of the left and right vehicle wheels 3 having passed on an unevenness generated due to degradation in a road surface on the basis of a detection result of acceleration in the acceleration sensor 17. In a case where the rolling of the vehicle 1 has been detected, the degradation detection unit 402 detects the degradation in the road surface.

The degradation detection unit 402 detects idle rotation of the vehicle wheels 3 on the basis of a detection result of a rotation speed of the vehicle wheels 3 in the wheel speed sensor 22. In a case where the idle rotation of the vehicle wheels 3 has been detected, the degradation detection unit 402 determines that the vehicle 1 has passed on a depression generated due to degradation in a road surface, and detects the degradation in the road surface.

The degradation detection unit 402 detects the degradation in the road surface on the basis of a detection result of a steering amount for the steering unit 4 in the steering angle sensor 19 or a detection result of an operation on the braking operation unit 6 in the brake sensor 18b. Consequently, it is possible to detect degradation in a road surface on the basis of a driving operation for a driver of the vehicle 1 avoiding the degradation in the road surface and thus to improve the accuracy of detecting the degradation in the road surface required to be repaired.

Specifically, in a case where a pattern (waveform) of a change in a steering amount detected by the steering angle sensor 19 is different from a pattern (waveform) of a change in a steering amount for the steering unit 4 of the vehicle 1 traveling on a road of which a road surface does not degrade, the degradation detection unit 402 detects degradation in a road surface. In a case where a pattern (waveform) of a change in a position of the braking operation unit 6 (brake pedal) detected by the brake sensor 18b is different from a pattern (waveform) of a change in a position of the braking operation unit 6 of the vehicle 1 traveling on a road of which a road surface does not degrade, the degradation detection unit 402 detects degradation in a road surface.

The timing calculation unit 403 calculates a timing (hereinafter, referred to as an imaging timing) at which the vehicle 1 passes through a position separated by a predetermined distance from a traveling position (hereinafter, referred to as a degradation position) at which degradation in a road surface is detected by the degradation detection unit 402 among traveling positions detected by the position detection unit 405, on the basis of a speed detected by the speed detection unit 401. Here, the predetermined distance is a preset distance, and is a distance at which the degradation position is included in an angle of view of the imaging unit 15.

Specifically, the timing calculation unit 403 calculates a time (hereinafter, referred to as a traveling time) required for the vehicle 1 to travel over the predetermined distance at a speed detected by the speed detection unit 401. The timing calculation unit 403 calculates a timing before the calculated traveling time (or a timing after the calculated traveling time) as an imaging timing, based on a timing at which the degradation in the road surface is detected by the degradation detection unit 402 as a reference.

In the present embodiment, in a case where a captured image obtained by the imaging unit 15a (rear camera) imaging the road surface is recorded, the timing calculation unit 403 calculates a timing at which the vehicle 1 passes through a position separated from a degradation position by a predetermined distance in an advancing direction of the vehicle 1, as an imaging timing. Specifically, the timing calculation unit 403 calculates a timing after a calculated traveling time as an imaging timing based on a timing at which the degradation is detected as a reference. Consequently, it is possible to analyze a degradation position by using a captured image obtained by imaging a road surface at a timing at which the vehicle 1 passes through a position separated from the degradation position by an identical distance regardless of a speed of the vehicle 1. As a result, it is possible to easily analyze the degradation position by using the captured image.

On the other hand, in a case where a captured image obtained by the imaging unit 15c (front camera) imaging the road surface is recorded, the timing calculation unit 403 calculates a timing at which the vehicle 1 passes through a position separated from a degradation position by a predetermined distance in a direction opposite to the advancing direction of the vehicle 1, as an imaging timing. Specifically, the timing calculation unit 403 calculates a timing before a calculated traveling time as an imaging timing based on a timing at which the degradation is detected as a reference. Consequently, it is possible to analyze a degradation position by using a captured image obtained by imaging a road surface at a timing at which the vehicle 1 passes through a position separated from the degradation position by an identical distance regardless of a speed of the vehicle 1. As a result, it is possible to easily analyze the degradation position by using the captured image.

In the present embodiment, the timing calculation unit 403 may change an imaging timing according to the vehicle wheels 3 having passed on a degradation position among the vehicle wheels 3 of the vehicle 1.

For example, in a case where the vehicle 1 is traveling along a curve or a turning, only either of the front wheels 3F and the rear wheels 3R may pass on a degradation position. In a case where only the front wheels 3F have passed on a degradation position when the vehicle 1 is traveling frontward, the timing calculation unit 403 delays an imaging timing by a wheelbase of the vehicle 1. On the other hand, in a case where only the rear wheels 3R have passed on a degradation position when the vehicle 1 is traveling frontward, the timing calculation unit 403 does not change an imaging timing.

Alternatively, in a case where only the front wheels 3F have passed on a degradation position when the vehicle 1 is traveling frontward, the timing calculation unit 403 does not change an imaging timing. On the other hand, in a case where only the rear wheels 3R have passed on a degradation position when the vehicle 1 is traveling frontward, the timing calculation unit 403 advances an imaging timing by a wheelbase of the vehicle 1.

Consequently, even in a case where either of the front wheels 3F and the rear wheels 3R have passed on a degradation position, a road surface can be imaged at an imaging timing of passing through a position separated from the degradation position by an identical distance, and thus it is possible to reduce an amount of image processing such as magnification of a captured image when the degradation position is analyzed by using the captured image and also to more easily analyze the degradation position by using the captured image.

The recording control unit 404 records a captured image obtained by the imaging unit 15 imaging the road surface at the imaging timing calculated by the timing calculation unit 403, on a nonvolatile storage unit such as the SSD 14f in correlation with the degradation position. In other words, the captured image obtained by imaging the road surface at a position separated from the degradation position by a predetermined distance is recorded on the SSD 14f regardless of a difference in a speed of the vehicle 1 when passing on the degradation position.

Consequently, it is possible to reduce an amount of image processing such as magnification of a captured image when the degradation position is specified by using the captured image, and also to more easily specify the degradation position by using the captured image. As a result, a road surface property measurement vehicle can be efficiently operated, for example, by the present device narrowing an operation location of the road surface property measurement vehicle, and it is also possible to reduce cost required to examine a road surface property.

It is possible to realize detection of degradation in a road surface and acquisition of a captured image of the degradation position by using existing components of the vehicle 1, such as the imaging unit 15 or the acceleration sensor 17, and thus to realize the vehicle 1 used to analyze the degradation position at low cost. A traveling position detected by the position detection unit 405 is recorded on the SSD 14f as a degradation position, and thus the degradation position can be recorded at a higher resolution than in a case of recording the degradation position by using kilo-posts of the road.

Since analysis of degradation in a road surface is possible by using a captured image stored in the SSD 14f, it is not necessary to go to the actual place in order to actually check a degradation position, and thus it is possible to reduce cost for movement or the like required to check the degradation position. Since analysis of degradation in a road surface is possible by using a captured image stored in the SSD 14f, many unspecified people can check a degradation position, and a professional such as a road repair company can determine whether or not a repair is necessary.

In the present embodiment, the recording control unit 404 controls the imaging unit 15 to start to image a road surface when degradation in the road surface is detected by the degradation detection unit 402. The recording control unit 404 extracts a captured image obtained by imaging the road surface at an imaging timing calculated by the timing calculation unit 403 from captured images obtained by the imaging unit 15 imaging the road surface, and records the captured image on the SSD 14f. Consequently, it is not necessary for the imaging unit 15 to image a road surface regardless of whether or not degradation in the road surface is detected by the degradation detection unit 402, and thus it is possible to reduce a load on the imaging unit 15.

Alternatively, the recording control unit 404 may control the imaging unit 15 to image a road surface only at an imaging timing calculated by the timing calculation unit 403, and may record a captured image obtained by imaging the road surface on the SSD 14f. Consequently, the imaging unit 15 may image the road surface only at an imaging timing, and thus it is possible to further reduce a load on the imaging unit 15. Alternatively, the recording control unit 404 may control the imaging unit 15 to image the periphery of the vehicle 1 at all times regardless of whether or not degradation in the road surface is detected by the degradation detection unit 402, may extract a captured image obtained by at an imaging timing calculated by the timing calculation unit 403 from captured images obtained through imaging in the imaging unit 15, and may record the captured image on the SSD 14f.

Next, with reference to FIG. 5, a description will be made of an example of a flow of a captured image recording process performed by the ECU 14 of the vehicle 1 according to the present embodiment. FIG. 5 is a flowchart illustrating an example of a flow of a captured image recording process performed by the ECU of the vehicle according to the present embodiment.

First, the degradation detection unit 402 executes a process of detecting degradation in a road surface of a road on which the vehicle 1 is traveling (step S501). The speed detection unit 401 detects a speed of the vehicle 1 on the basis of a detection result of a rotation speed of the vehicle wheels 3 in the wheel speed sensor 22 (step S502).

The timing calculation unit 403 determines whether or not degradation in the road surface has been detected by the degradation detection unit 402 (step S503). In a case where the degradation in the road surface has not been detected (step S503: No), the flow returns to step S501, and the degradation detection unit 402 continuously performs the process of detecting degradation in the road surface.

On the other hand, in a case where the degradation in the road surface has been detected (step S503: Yes), the imaging unit 15a (rear camera) starts to image the rear of the vehicle 1, and the timing calculation unit 403 calculates an imaging timing at which the vehicle 1 passes through a position separated by a predetermined distance in an advancing direction of the vehicle 1 from a degradation position that is a traveling position at which the degradation in the road surface is detected among traveling positions of the vehicle 1 detected by the position detection unit 405 on the basis of a speed of the vehicle 1 detected by the speed detection unit 401 (step S504).

Next, among captured images obtained through imaging in the imaging unit 15a, the recording control unit 404 records a captured image obtained at the imaging timing calculated by the timing calculation unit 403 on a storage unit such as the SSD 14f in correlation with the degradation position (step S505).

As mentioned above, according to the vehicle 1 of the present embodiment, it is possible to reduce a processing amount due to image processing such as magnification of a captured image when a degradation position is specified by using the captured image and thus to easily specify the degradation position by using the captured image. As a result, a road surface property measurement vehicle can be efficiently operated, for example, by the present device narrowing an operation location of the road surface property measurement vehicle, and it is also possible to reduce cost required to examine a road surface property.

It is possible to realize detection of degradation in a road surface and acquisition of a captured image of the degradation position by using existing components of the vehicle 1, such as the imaging unit 15 or the acceleration sensor 17, and thus to realize the vehicle 1 used to analyze the degradation position at low cost. A traveling position detected by the position detection unit 405 is recorded on the SSD 14f as a degradation position, and thus the degradation position can be recorded at a higher resolution than in a case of recording the degradation position by using kilo-posts of the road.

Since analysis of degradation in a road surface is possible by using a captured image stored in the SSD 14f, it is not necessary to go to the actual place in order to actually check a degradation position, and thus it is possible to reduce cost for movement or the like required to check the degradation position. Since analysis of degradation in a road surface is possible by using a captured image stored in the SSD 14f, many unspecified people can check a degradation position, and a professional such as a road repair company can determine whether or not a repair is necessary.

As an example, a road degradation information collecting device according to an aspect of this disclosure includes a position detection unit that detects a traveling position of a vehicle; a speed detection unit that detects a speed of the vehicle; a degradation detection unit that detects degradation in a road surface of a road on which the vehicle is traveling; a timing calculation unit that calculates a timing at which the vehicle passes through a position separated by a predetermined distance from a degradation position that is the traveling position at which the degradation in the road surface is detected among traveling positions detected by the position detection unit on the basis of the speed detected by the speed detection unit; and a recording control unit that records a captured image obtained by imaging the road surface with an imaging unit mounted on the vehicle at the timing calculated by the timing calculation unit, on a storage unit in correlation with the degradation position. Therefore, a road surface property measurement vehicle can be efficiently operated, for example, by the present device narrowing an operation location of the road surface property measurement vehicle, and it is also possible to reduce cost required to examine a road surface property.

As an example, the road degradation information collecting device according to the aspect of this disclosure may further include an acceleration sensor that detects an acceleration applied to the vehicle, and the degradation detection unit may detect the degradation in the road surface on the basis of a detection result of the acceleration in the acceleration sensor. Therefore, as an example, it is possible to improve the accuracy of detecting degradation in a road surface required to be repaired.

As an example, the road degradation information collecting device according to the aspect of this disclosure may further include an operation detection unit that detects an operation on a steering unit or a braking operation unit of the vehicle, and the degradation detection unit may detect the degradation in the road surface on the basis of a detection result of the operation on the steering unit or the braking operation unit in the operation detection unit. Therefore, as an example, it is possible to improve the accuracy of detecting degradation in a road surface required to be repaired.

As an example, in the road degradation information collecting device according to the aspect of this disclosure, the imaging unit may be a rear camera provided to image the rear of the vehicle, and the timing calculation unit may calculate a timing at which the vehicle passes through a position separated from the degradation position by the predetermined distance in an advancing direction of the vehicle. Therefore, as an example, it is possible to easily analyze a degradation position by using a captured image.

As an example, in the road degradation information collecting device according to the aspect of this disclosure, the imaging unit may be a front camera provided to image the front of the vehicle, and the timing calculation unit may calculate a timing at which the vehicle passes through a position separated from the degradation position by the predetermined distance in a direction opposite to an advancing direction of the vehicle. Therefore, as an example, it is possible to easily analyze a degradation position by using a captured image.

As an example, in the road degradation information collecting device according to the aspect of this disclosure, the degradation detection unit may detect the degradation in the road surface in a case where a waveform of a change in a direction in which the acceleration detected by the acceleration sensor is applied is different from a preset waveform. Therefore, as an example, it is possible to improve the accuracy of detecting degradation in a road surface required to be repaired.

As an example, in the road degradation information collecting device according to the aspect of this disclosure, the degradation detection unit may detect the degradation in the road surface in a case where a change amount of an acceleration detected by the acceleration sensor based on an acceleration applied to the vehicle traveling on a road that does not degrade as a reference is equal to or more than a preset threshold value. Therefore, as an example, it is possible to improve the accuracy of detecting degradation in a road surface required to be repaired.

As an example, in the road degradation information collecting device according to the aspect of this disclosure, the imaging unit may start to image the road surface when the degradation in the road surface is detected by the degradation detection unit, and the recording control unit may extract a captured image obtained at the timing calculated by the timing calculation unit from captured images obtained through imaging in the imaging unit, and records the captured image on the storage unit. Therefore, as an example, it is possible to reduce a load on the imaging unit.

As an example, in the road degradation information collecting device according to the aspect of this disclosure, the imaging unit may image the road surface only at the timing calculated by the timing calculation unit. Therefore, as an example, it is possible to reduce a load on the imaging unit.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A road degradation information collecting device comprising:
a position detection unit that detects a traveling position of a vehicle;
a speed detection unit that detects a speed of the vehicle;
a degradation detection unit that detects degradation in a road surface of a road on which the vehicle is traveling;
a timing calculation unit that calculates a timing at which the vehicle passes through a position separated by a predetermined distance from a degradation position that is the traveling position at which the degradation in the road surface is detected among traveling positions detected by the position detection unit on the basis of the speed detected by the speed detection unit; and
a recording control unit that records a captured image obtained by imaging the road surface with an imaging unit mounted on the vehicle at the timing calculated by the timing calculation unit, on a storage unit in correlation with the degradation position.

2. The road degradation information collecting device according to claim 1, further comprising:
an acceleration sensor that detects an acceleration applied to the vehicle, wherein
the degradation detection unit detects the degradation in the road surface on the basis of a detection result of the acceleration in the acceleration sensor.

3. The road degradation information collecting device according to claim 1, further comprising:
an operation detection unit that detects an operation on a steering unit or a braking operation unit of the vehicle, wherein
the degradation detection unit detects the degradation in the road surface on the basis of a detection result of the operation on the steering unit or the braking operation unit in the operation detection unit.

4. The road degradation information collecting device according to claim 2, wherein
the imaging unit is a rear camera provided to image the rear of the vehicle, and
the timing calculation unit calculates a timing at which the vehicle passes through a position separated from the degradation position by the predetermined distance in an advancing direction of the vehicle.

5. The road degradation information collecting device according to claim 3, wherein
the imaging unit is a front camera provided to image the front of the vehicle, and
the timing calculation unit calculates a timing at which the vehicle passes through a position separated from the degradation position by the predetermined distance in a direction opposite to an advancing direction of the vehicle.

6. The road degradation information collecting device according to claim 2, wherein
the degradation detection unit detects the degradation in the road surface in a case where a waveform of a change in a direction in which the acceleration detected by the acceleration sensor is applied is different from a preset waveform.

7. The road degradation information collecting device according to claim 2, wherein
the degradation detection unit detects the degradation in the road surface in a case where a change amount of the acceleration detected by the acceleration sensor based on an acceleration applied to the vehicle traveling on a road that does not degrade as a reference is equal to or more than a preset threshold value.

8. The road degradation information collecting device according to claim 4, wherein
the imaging unit starts to image the road surface when the degradation in the road surface is detected by the degradation detection unit, and
the recording control unit extracts a captured image obtained at the timing calculated by the timing calculation unit from captured images obtained through imaging in the imaging unit, and records the captured image on the storage unit.

9. The road degradation information collecting device according to claim 4, wherein
the imaging unit images the road surface only at the timing calculated by the timing calculation unit.
